(19) United States
(12) Patent Application Publication
(10) Pub. No.: US 2007/0099711 A1
(43) Pub. Date: May 3, 2007

(54) Flexible annular element made of elastomeric material for an elastic device coupling two shafts and an elastic coupling device comprising the element

(75) Inventor: Patrick Salmon, Laventie (FR)

Correspondence Address: CASELLA & HESPOS, 274 MADISON AVENUE, NEW YORK, NY, 10016, US

(73) Assignee: Colmant Cuvelier SA, Lille (FR)

(21) Appl. No.: 11/582,788

(22) Filed: Oct. 18, 2006

(30) Foreign Application Priority Data
Oct. 19, 2005 (FR) 05 10638

(51) Int. Cl. F16D 3/00

(52) U.S. Cl. 464/80

(57) ABSTRACT

A flexible annular element made of elastomeric material (1) is provided for an elastic coupling device to connect two substantially coaxial shafts (11, 12). The device has a first flange (7) secured to the end of the first shaft (11), a second flange (8) secured to the end of the second shaft (12); and a clamp having supporting surfaces (9, 9a, 10, 10a) for clamping both sides of the annular edges (3, 4, 5, 6) of the annular element. The annular edges (3, 4, 5, 6) are provided, at least in the region of their contact with said bearing surfaces, with a lining having a slip coefficient greater than that of the elastomer of the flexible annular element.

### BACKGROUND OF THE INVENTION

1. Field of the Invention

The present invention relates to a flexible annular element made of elastomeric material for an elastic coupling device intended to connect two substantially coaxial shafts, this device comprising:

a first flange secured to the end of one of the shafts;

a second flange, opposite the first, secured to the end of the other shaft; and

means provided on the peripheral edge of each flange and having bearing surfaces shaped for clamping both sides of the annular edges of said flexible annular element. It additionally relates to an elastic coupling device comprising the previously mentioned flexible annular element.

2. Description of the Related Art

The device and annular element of the above type have been known for a long time (see for example FR-1 292 008, FR-2 042 835, GB-1 021 419 and EP 790 424) and have been used in the most various applications, their function being to transmit torque from a first (driving) shaft to a second (driven) shaft while absorbing, by virtue of the presence of the flexible annular element, vibrations, jerks, axial or angular misalignments and/or any axial movements of which the second shaft could be the source.

In known devices of the type recalled above, the clamping force exerted by the bearing surfaces on the annular edges of the flexible elastomeric element is chosen so as to prevent any relative slip between these surfaces and these edges, since such slip would inevitably lead to burning of these edges by reason of the elastomeric nature of the flexible element and; in addition, the tear strength of the flexible element is chosen so that the latter breaks when subjected to a torque overload likely to harm the engine upstream to said engine shaft.

Thus, when a small torque overload is produced in these devices, the annular element deforms and absorbs this overload.

However, when this overload exceeds a threshold value, by reason of the absence of any possibility of sliding between the bearing surfaces and the flexible element, the latter breaks, which has the effect to preventing damage to the engine upstream to the engine shaft.

Similarly, when being subjected for a long time to vibrations and/or jerks, this element becomes weak and it may break at any moment.

Now, the latter event can be particularly prejudicial if it occurs during a manufacturing process that must not be stopped before its normal time limit.

In order to prevent this type of problem, users have chosen to replace the flexible annular element as often as possible so as to have a good guarantee that the latter will not break during a manufacturing process.

This procedure is obviously financially unsatisfactory since users frequently change a flexible element when the latter is still in a state in which it can be used.

### SUMMARY OF THE INVENTION

To this end, the invention relates to the annular element defined above, this element being characterized in that its annular edges are provided, at least in the region of the bearing surfaces shaped for clamping these annular edges, a lining having a slip coefficient greater than that of the elastomer constituting said flexible annular element.

It will be readily understood that, by virtue of this construction, by a suitable choice of the nature of the lining and, on account of this, its slip coefficient, when a torque overload is produced greater than the torque that can be withstood by the annular element, relative slip will occur between the annular edges of the flexible element and the bearing surfaces clamping these edges, which will prevent tearing and/or breaking of said annular element.

The goal that is the basis of the present invention is to absorb, by slip, any untimely torque overload which the annular element could not normally withstand.

Such slip admittedly brings about a certain amount of wear of the elastic element. However this wear is slow and enables users to continue and finish the manufacturing programme in progress without any problem.

The slip in question can be observed visually by the operator and moreover it is usually accompanied by a slight emission of smoke resulting from superficial burning of the abovementioned lining under the effect of the slip-induced heat.

This visual indication is also a warning for the operator, who consequently will know that, by reason of the slip that is produced and the resulting wear, the annular element should be replaced at the end of the manufacturing programme in progress.

On the other hand, if no significant slip occurs during a programme, the operator will know that there is no reason to replace the annular element for the next programme, with the saving that this could generate.

According to one embodiment, the abovementioned lining applied to the edges of the annular element comprises a textile material, such as a fabric, for example made of woven cotton.

According to a preferred embodiment, the fabric has elastomeric beads advantageously distributed in a substantially uniform manner on its face intended to come into contact with the bearing surfaces.

By means of these elastomeric beads, it is possible to adjust the slip coefficient of the fabric. The greater the number and/or size of these beads, the lower the slip coefficient becomes.

The present invention extends to an assembly for an elastic coupling device as defined above, this assembly being characterized in that it includes the flexible annular element made of elastomeric material described above and optionally means for detecting a difference in rotational speed between the two flanges.

These means of detection act as a warning, as is the case of the emission of smoke mentioned above.

The invention also relates to the elastic coupling device described above, fitted with the annular element made of elastomeric material comprising the lining defined above, and optionally means for detecting the difference in rotational speed which are referred to above.

### BRIEF DESCRIPTION OF THE DRAWINGS

In a non-limiting manner, the invention will now be described in greater detail with reference to the drawings below which represent an embodiment of this invention, drawings in which:

FIG. 1 is a cut-away perspective view of an elastic coupling device according to the invention.

FIG. 2 is a schematic view in radial cross section of the annular element made of elastomeric material fitted to the device of FIG. 1.

FIG. 3 is a greatly enlarged representation of the outer face of the lining.

### DETAILED DESCRIPTION OF THE PREFERRED EMBODIMENTS

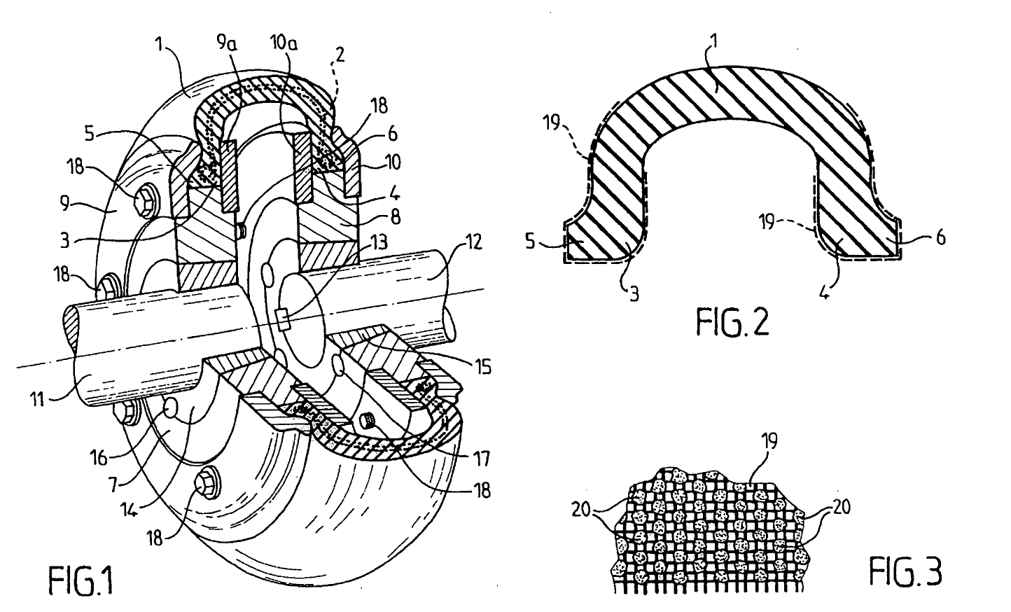

As shown in FIG. 1, the coupling device according to the invention comprises an annular element 1 made of elastomeric material (rubber for example), this element having a radial cross section substantially in the form of a U.

The element 1 advantageously has the structure of a tyre casing, a structure within which reinforcements made of textile material (fabric) and/or of metal are embedded, as shown in 2 on FIG. 1, so as to provide it with the desired flexibility according to the intended use.

This element 1 comprises two annular edges 3, 4 each provided with a short outer axial extension 5, 6.

The device of FIG. 1 additionally comprises a first flange 7 and a second flange 8 facing each other.

Outer rings 9, 10 are provided respectively at the periphery and on the outer face of the flanges 7, 8 and inner rings 9a, 10a respectively are provided on the inner face of said flanges, the rings 9, 9a facing each other, like the rings 10, 10a do.

The flange 7 is dimensioned so as to receive a shaft (driving shaft) 11 and the flange 8 is dimensioned so as to receive a shaft (driven shaft) 12. These shafts are secured to the respective flanges by pins 13 and conical elements 14, 15 inserted between the inner face of the flanges and the cylindrical surfaces of the shafts, these conical elements being themselves secured to the flanges by a set of pins 16, 17.

In addition, the annular edges 3, 4 (and their respective extensions 5, 6) of the annular element 1 are positioned respectively in the space defined between the peripheral part of the flanges 7, 8 and the rings 9, 9a and 10, 10a.

The rings 9, 9a on the one hand and the rings 10, 10a on the other hand, are moreover forced towards each other, which has the effect of firmly clamping the annular edges 3, 4 and the extensions 5, 6.

This result can be obtained by providing axial tapped holes extending through the ring 9, the flange 7 and the ring 9a and axial tapped holes extending through the ring 10, the flange 8 and the ring 10a, these holes receiving tightening bolts 18.

Tightening these bolts causes the rings 9, 9a and 10, 10a to come together while strongly compressing said annular edges 3, 4 and the extensions 5, 6 together.

As shown in FIG. 1, the outer peripheral edge of the rings 9, 10 is advantageously shaped so as to exert an increased clamping effect on the part of the annular element 1 situated just above the extensions 5, 6.

The force tightening the annular edges of the flexible element is chosen so as to hold these edges perfectly between the rings 9, 9a and 10, 10a.

It may be added that for reasons of ease of assembly/disassembly, the annular element 1 is advantageously split radially in one location.

According to the present invention, a lining 19 is provided, shown schematically as a dotted line in FIG. 2, this lining being positioned on the annular edges 3, 4 and the extensions 5, 6 of the element 1.

This lining 19 advantageously consists of a woven cotton fabric on the surface of which beads of elastomer 20 are positioned, having the same chemical nature as the elastomeric material constituting the element 1.

The lining 19 possesses the desired slip properties according to the invention, as has been previously explained, it being possible to modify these properties at will by the number and/or size of the beads 20.

In the absence of this lining, any relative slip between the edges 3, 4 and the extensions 5, 6 and the inner faces of the rings 9, 9a and 10, 10a would be impossible.

On the other hand, by virtue of the presence of said lining, such slip will occur as soon as an excessive torque overload appears, the deformation of the element 1 and this slip absorbing this overload and thus preventing the element 1 from breaking.

It should be stated that putting the lining 19 in place on the annular element 1 is very easy, since it can be carried out in particular during the production of this element 1. It is in fact sufficient when the blank of element 1 is prepared (by lamination) to put in place suitable fabrics at suitable locations, and then to carry out hot calendering under pressure, an operation during which the desired outer lining 19 will be formed with the presence of beads formed by migration of a small quantity of elastomer from the inner layers of the annular element to the outer surface of the lining 19.

The device described in this way may be supplemented by a device for detecting a difference in rotational speed between the two flanges.

It may consist of any known device, of which very many types are available on the market.

It could for example consist of an underspeed detector, applied to the driven shaft 12 or the flange 8 and comprising an indicator signalling that said flange 8 has rotated at a speed less than the nominal speed (that of the order of the engine).

This indication is the sign that a slip of the annular element 1 has occurred, which, when the manufacturing process is ended, will lead to the replacement of said element.

In order to carry out this replacement, it will be sufficient to release the bolts 18, to withdraw the deteriorated worn element 1, to substitute a new element and once again to tighten the bolts 18 to the desired degree.

What is claimed is:

1. Flexible annular element made of elastomeric material (1) for an elastic coupling device intended to connect two substantially coaxial shafts (11, 12), this device comprising:
a first flange (7) secured to the end of one (11) of the shafts;
a second flange (8), opposite the first, secured to the end of the other shaft (12); and
means provided on a peripheral edge of each flange and having bearing surfaces (9, 9a, 10, 10a) shaped for clamping both sides of the annular edges (3, 4, 5, 6) of said flexible annular element,
characterized in that its annular edges (3, 4, 5, 6) are provided, at least in the region of their contact with said bearing surfaces, with a lining (19) having a slip coefficient greater than that of the elastomer constituting said flexible annular element.

2. The flexible annular element of claim 1, characterized in that said lining comprises a textile material.

3. The flexible annular element of claim 2, characterized in that said textile material is a fabric.

4. The flexible annular element of claim 3, characterized in that said fabric is made of woven cotton.

5. The flexible annular element of claim 4, characterized in that said fabric has elastomeric beads (20) on its face intended to come into contact with the bearing surfaces.

6. The flexible annular element of claim 5, characterized in that said beads are distributed substantially uniformly over said face.

7. The flexible annular element of claim 3, characterized in that said fabric has elastomeric beads (20) on its face intended to come into contact with the bearing surfaces.

8. The flexible annular element of claim 7, characterized in that said beads are distributed substantially uniformly over said face.

9. Assembly for an elastic coupling device intended to connect two substantially coaxial shafts and comprising:
a first flange (7) secured to the end of one (11) of the shafts;
a second flange (8), opposite the first, secured to the end of the other shaft (12); and
means provided on a peripheral edge of each flange and having bearing surfaces (9, 9a, 10, 10a) shaped for clamping both sides of the annular edges (3, 4, 5, 6) of a flexible annular element (1) made of elastomeric material, characterized in that said flexible annular element is in accordance with claim 1 and in that it additionally includes means for detecting a difference in speed of rotation between the two flanges.

10. Elastic coupling device intended to connect two substantially coaxial shafts (11, 12) and comprising:
a first flange (7) secured to the end of one (11) of the shafts;
a second flange (8), opposite the first, secured to the end of the other shaft (12); and
means provided on a peripheral edge of each flange and having shaped bearing surfaces (9, 9a, 10, 10a) for clamping both sides of the annular edges of a flexible annular element (1) made of elastomeric material, characterized in that said flexible annular element is in accordance with claim 1.

11. The elastic coupling of claim 10, further comprising means for detecting a difference in speed of rotation between the two flanges.
